(19) United States
(12) Patent Application Publication
(10) Pub. No.: US 2015/0120248 A1
(43) Pub. Date: Apr. 30, 2015

(54) SYSTEM AND METHOD FOR DIAGNOSING MACHINE FAULTS

(71) Applicant: General Electric Company, Schenectady, NY (US)

(72) Inventors: Dustin Ross Garvey, Oakland, CA (US); Rui Xu, Rexford, NY (US); Feng Xue, Clifton Park, NY (US); Bouchra Bouqata, Troy, NY (US); Nicholas Edward Roddy, Guilderland, NY (US)

(73) Assignee: General Electric Company, Schenectady, NY (US)

(21) Appl. No.: 14/067,179

(22) Filed: Oct. 30, 2013

(51) Int. Cl. G01M 99/00

(52) U.S. Cl. CPC G01M 99/005
USPC 702/185

(57) ABSTRACT

A method for diagnosing machine faults, includes obtaining sensory data from a machine and obtaining a plurality of measured structural features based on the sensory data. The method also includes obtaining a plurality of reference cases corresponding to the sensory data, from a database. The plurality of reference cases include a plurality of reference structural features and a plurality of fault identifiers. The method further includes computing a statistical parameter based on the plurality of reference cases and obtaining a first subset of reference structural features from the plurality of reference structural features based on the computed statistical parameter. The method also includes computing a plurality of similarity values based on the obtained first subset of reference structural features and the plurality of measured structural features. The method further includes identifying at least one fault identifier among the plurality of fault identifiers, based on the computed plurality of similarity values.

### BACKGROUND

The subject matter disclosed herein generally relates to analyzing a fault log of a machine. More specifically, the subject matter relate to method and system for a diagnosis, and repair of the machine based on data associated with the operation of the machine.

Case Based Reasoning (CBR), is a technique of problem solving based on rules and behaviors learnt from experiential knowledge (memory of past experiences or cases). CBR focuses on indexing, retrieval, reuse, and archival of cases. CBR is used generally for diagnosis and repair of systems related to healthcare, transportation, and other infrastructure related systems.

CBR has been employed in equipment monitoring and remote diagnostics, call center automation, and in productivity tools. Quality management initiatives involving obtaining measurement data, analyzing the data, making improvements based on the data, and maintaining the improvement by continuously collecting data suits adoption of CBR techniques.

### BRIEF DESCRIPTION

In accordance with one aspect of the present technique, a method is disclosed. The method includes obtaining sensory data from a machine and obtaining a plurality of measured structural features based on the sensory data. The method also includes obtaining a plurality of reference cases corresponding to the sensory data, from a database. The plurality of reference cases include a plurality of reference structural features and a plurality of fault identifiers. The method further includes computing a statistical parameter based on the plurality of reference cases and obtaining a first subset of reference structural features from the plurality of reference structural features based on the computed statistical parameter. The method also includes computing a plurality of similarity values based on the obtained first subset of reference structural features and the plurality of measured structural features. The method further includes identifying at least one fault identifier among the plurality of fault identifiers, based on the computed plurality of similarity values.

In accordance with another aspect of the present technique, a system is disclosed. The system includes a data acquisition module communicatively coupled to a sensing unit of a machine. The data acquisition module is configured to obtain a sensory data including a plurality of measured structural features from the sensing unit. The system further includes a training module communicatively coupled to the data acquisition module, the training module including a database having a plurality of reference cases corresponding to the sensory data. The plurality of reference cases include a plurality of reference structural features and a plurality of fault identifiers. The system also includes an optimizer module communicatively coupled to the database. The optimizer module is configured to obtain a first subset of reference structural features from the plurality of reference structural features. The system further includes an execution module communicatively coupled to the data acquisition module and the optimizer module. The execution module is configured to identify at least one fault identifier among the plurality of fault identifiers, based on the plurality of measured structural features and the first subset of reference structural features.

In accordance with another aspect of the present technique, a non-transitory computer readable medium encoded with a program to instruct at least one processor based device to diagnose machine faults is disclosed. The program instructs the at least one processor based device to obtain sensory data from a machine and obtain a plurality of measured structural features based on the sensory data. The program also instructs the at least one processor based device to obtain a plurality of reference cases corresponding to the sensory data, from a database. The plurality of reference cases include a plurality of reference structural features and a plurality of fault identifiers. The program also instructs the at least one processor based device to compute a statistical parameter based on the plurality of reference cases and obtain a first subset of reference structural features from the plurality of reference structural features based on the computed statistical parameter. The program further instructs the at least one processor based device to compute a plurality of similarity values based on the obtained first subset of reference structural features and the plurality of measured structural features and identify at least one fault identifier among the plurality of fault identifiers, based on the computed plurality of similarity values.

### DRAWINGS

These and other features and aspects of embodiments of the present invention will become better understood when the following detailed description is read with reference to the accompanying drawings in which like characters represent like parts throughout the drawings, wherein:

FIG. 1 is a diagrammatic illustration of a system for diagnosis of an operating condition of a machine in accordance with an exemplary embodiment;

FIG. 2 is a schematic illustration of a case having a plurality of structural features derived from data obtained from a machine in accordance with an exemplary embodiment;

FIG. 3 is an illustration of a table having a plurality of reference cases, structural features associated with each case, and a fault identifier associated with each reference case in accordance with an exemplary embodiment;

FIG. 4 is a schematic flow diagram illustrating generation of a plurality of reference structural features, and fault identifiers from a case identification number in accordance with an exemplary embodiment;

FIG. 5 is a schematic flow diagram illustrating identification of nuisance structural features from a plurality of reference structural features in accordance with an exemplary embodiment;

FIG. 6 is a schematic flow diagram illustrating identification of a first subset of instructive structural features in accordance with an exemplary embodiment;

FIG. 7 is a table for computation of a statistical significance parameter in accordance with an exemplary embodiment;

FIG. 8 is a schematic flow diagram illustrating generation of a plurality of fault identifiers in accordance with an exemplary embodiment; and

FIG. 9 is a flow chart illustrating steps involved in identification of at least one fault identifier from a sensory data obtained from an operating machine in accordance with an exemplary embodiment.

### DETAILED DESCRIPTION

Embodiments of the present disclosure relate to a system and a method for performing at least one of a diagnosis of a condition of operation and a repair of a diagnosed condition of a malfunctioning machine based on measured data associated with the operation of the malfunctioning machine. Specifically, in certain embodiments, a plurality of measured structural features are obtained from sensory data of a machine. A plurality of reference cases corresponding to the sensory data are obtained from a database. The plurality of reference cases includes a plurality of reference structural features and a plurality of fault identifiers. A statistical parameter is computed based on the plurality of reference cases. A first subset of reference structural features from the plurality of reference structural features are obtained based on the computed statistical parameter A plurality of similarity values are computed based on the obtained first subset of reference structural features and the plurality of measured structural features. At least one fault identifier among the plurality of fault identifiers is identified based on the computed plurality of similarity values.

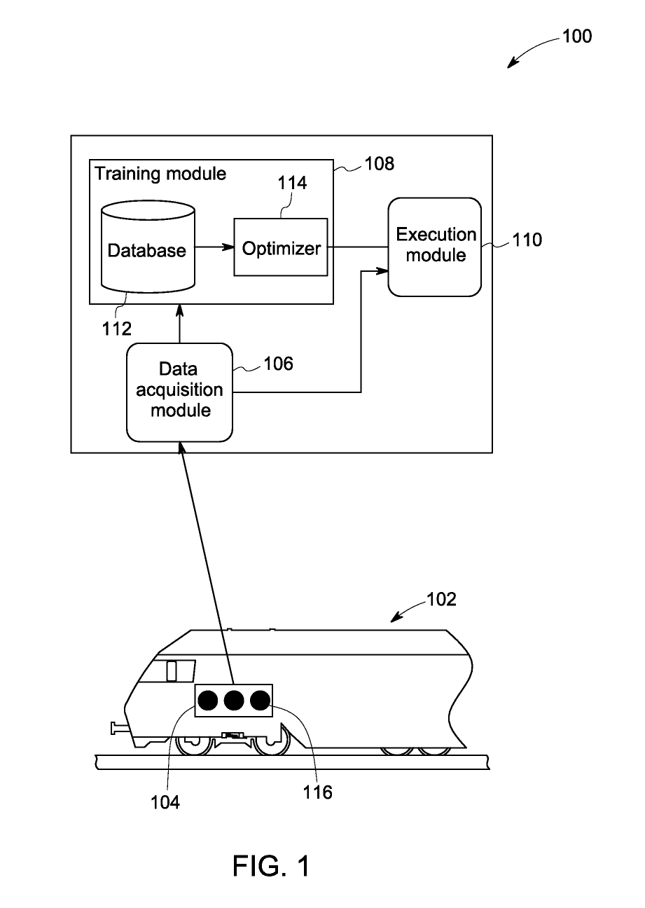

FIG. 1 illustrates a schematic diagram of a fault identifier system 100 used for diagnosis of an operation condition of a machine 102. It should be noted herein that the fault identifier system 100 is a case based reasoning system. The system 100 includes a sensing unit 104 having a plurality of sensors 116 for generating a sensory data indicative of an operating condition of the machine 102. In the illustrated embodiment, the machine 102 is a locomotive. In another embodiment, the machine 102 may be a medical imaging modality such as a MRI machine, a CT machine, or the like. In another embodiment, the machine 102 may be an aircraft engine or a power generation system. It should be noted herein that the fault identifier system 100 is applicable to other type of machines that require diagnosis of an operating condition. The sensory data includes information required to determine an operating condition of the machine 102. A portion of the sensory data used to identify the operating condition of the machine 102 is referred to herein as a “case”. The case includes a plurality of structural features representative of a plurality of the fault conditions (faults) of the machine 102. The term “structural feature” used herein refers to a fault or a sequence of faults of the machine 102.

A data acquisition module 106 is communicatively coupled to the sensing unit 104. The data acquisition module 106 is configured to receive the sensory data from the sensing unit 104. The data acquisition module 106 may receive sensory data from the sensing unit 104 through a communication link such as a wired, a wireless, or an internet network. In one embodiment, the data acquisition module 106 may be a standalone customized hardware component. In another embodiment, the data acquisition module 106 may be stored in a memory and executable by a processor. The system 100 further includes a training module 108 communicatively coupled to the data acquisition module 106. In the illustrated embodiment, the training module 108 includes a database 112 and an optimizer module 114. The database 112 may be used to store a plurality of reference cases corresponding to the sensory data. The plurality of reference cases includes a plurality of reference structural features and a plurality of fault identifiers. In one embodiment, the database 112 may be an off-the-shelf database module integrated with the optimizer module 114. The term “reference case” refers to a previously labeled processed case stored in the database 112. The term ‘fault identifier’ refers to an operating condition of the machine 102 of the machine 102 associated with the reference case. In one embodiment, the training module 108 may be a standalone customized hardware component. In another embodiment, the training module 108 may be stored in a memory and executable by a processor. In an embodiment where the data acquisition module 106 is disposed on the machine 102, the training module 108 receives the sensory data through a communication link from the data acquisition module 106.

The optimizer module 114 is communicatively coupled to the database 112 and configured to obtain a first subset of reference structural features from the plurality of reference structural features. The details of obtaining the first subset of reference structural features are explained in greater detail with reference to subsequent figures. In one embodiment, the optimizer module 114 may be a customized hardware component. In another embodiment, the optimizer module 114 may be stored in a memory and executable by a processor. In an alternate embodiment, the optimizer module 114 may be a sub-module implemented either as hardware component or software component within the training module 108. In certain other embodiments, the optimizer module 114 may be integrated with the training module 108.

The system 100 also includes an execution module 110 communicatively coupled to the data acquisition module 106 and the optimizer module 114. The execution module 110 is configured to identify at least one fault identifier among the plurality of fault identifiers, based on the plurality of measured structural features and the first subset of reference structural features. In one embodiment, the execution module 110 may be a customized hardware component. In another embodiment, the execution module 110 may be stored in a memory and executable by a processor.

In one embodiment, at least one module of the data acquisition module 106, the training module 108, and the execution module 110 may be a customized hardware component designed to perform respective specified functionality. In an alternate embodiment, at least one module of the data acquisition module 106, the training module 108, and the execution module 110 may be a software component stored in at least one memory and executed by at least one processor-based unit. In an exemplary embodiment, some modules of the training module 108, the optimizer module 114, and the execution module 110 are executed by a first processor-based unit. In such an embodiment, the remaining modules of the training module 108, the optimizer module 114, and the execution module 110 are executed by a second processor-based unit communicatively coupled with the first processor-based unit. Data may be exchanged between the first processor-based unit and the second processor-based unit depending on the configuration of the system.

At least one processor based unit may include at least one arithmetic logic unit, microprocessor, general purpose controller or other processor arrays to perform computations, and a memory module. The processing capability of at least one processor-based unit, in one embodiment, may be limited to retrieval of data and transmission of data. The processing capability of at least one processor-based unit, in another embodiment, may include performing more complex tasks such as obtaining the measured structural features from the sensory data, obtaining reference structural features from the reference cases, and the like. In other embodiments, other type of processors, operating systems, and physical configurations are also envisioned. The processor-based unit may also include or be communicatively coupled to at least one memory module. The memory module may be a non-transitory storage medium. For example, the memory module may be a dynamic random access memory (DRAM) device, a static random access memory (SRAM) device, flash memory or other memory devices. In one embodiment, the memory module also includes a non-volatile memory or a storage device such as a hard disk drive, a floppy disk drive, a compact disc read only memory (CD-ROM) device, a digital versatile disc read only memory (DVD-ROM) device, a digital versatile disc random access memories (DVD-RAM) device, a digital versatile disc rewritable (DVD-RW) device, a flash memory device, or other non-volatile storage devices. In one embodiment, the non-transitory computer readable medium is encoded with a program to instruct at least one processor-based device to identify fault of the machine 102.

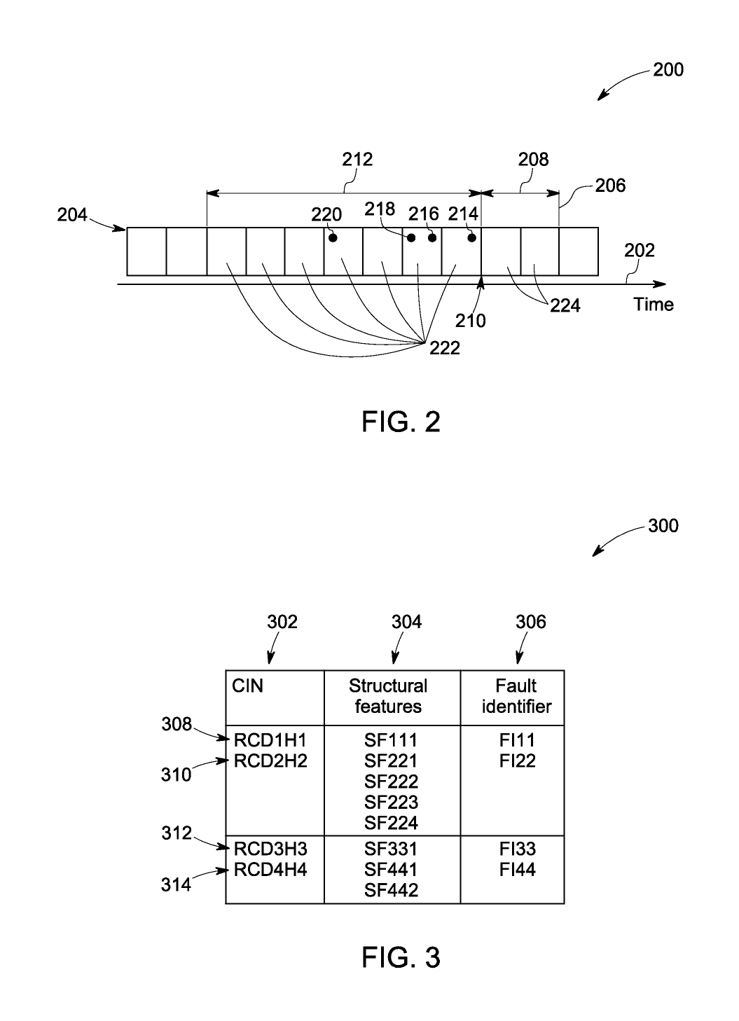

FIG. 2 is schematic representation of a case 200 having a plurality of structural features derived from data generated from a machine in accordance with an exemplary embodiment. The case 200 is illustrated with an x-axis 202 representative of time and a machine data 204 having a plurality of data units 222. The generation of the plurality of data units 222 with reference to time is shown herein. In the illustrated embodiment, each of the data units 222 includes the machine data 204 generated over a period of 24 hours. In other embodiments, each of the data units 222 may have machine data for a different time period i.e. less than 24 hours or greater than 24 hours. A group of sequentially generated data units 222 representative of an operating condition of the machine constitute the case 200. In the illustrated embodiment, the case 200 begins at a time instance 210 and spans over a fixed duration 212. In the illustrated embodiment, the fixed duration 212 extends over a period of several days, each data unit represent approximately a duration of one day. The exemplary case 200 is represented by a case identification number 206. It should be noted herein that the terms ‘case identification number’ and ‘CIN’ are used interchangeably. The CIN 206 is generated at a time instance along the x-axis 202, when an operating condition associated with the machine is reported.

In the illustrated embodiment, the case 200 represented by the CIN 206, includes a plurality of structural features 214, 216, 218, 220 generated within the fixed duration 212. A variable duration 208 between the time instance 210 (representative of the start of the case 200) and the CIN 206, includes a plurality of data units 224. It should be noted herein that the duration 208 does not include any of the plurality of structural features. In the illustrated embodiment, two data units 224 spans over the variable duration 208 extending over two days. The data units 222 spanning over the fixed duration 212 are stored in a data base. The term “structural feature” referred herein refers to a fault condition of the machine. For example, the plurality of structural features 214, 216, 218, 220 may be representative of fault conditions of the machine. In an exemplary embodiment, the structural feature may refer to a sequence of faults. As an example, the faults 216, 218 as a sequence may be treated as one structural feature. In alternative embodiments, the term “structural feature” may include other structures such as an n-tuple or a graph, derived from a plurality of fault conditions.

It should be noted herein that the machine data 204 may also be referred to as “sensory data”. A case including the sensory data may be referred to as a “measured case”. A plurality of structural features in the measured case may be referred to herein as “measured structural features”. The machine data processed, labeled, and stored in a database may be referred to herein as “reference data”. A case including the reference data may be referred to herein as a “reference case”. A plurality of structural features in the reference case may be referred to herein as “reference structural features”. The measured case and the reference case have a same data format as represented by the schematic diagram of FIG. 2.

FIG. 3 illustrates a table 300 stored in a database having a plurality of reference cases in accordance with an exemplary embodiment. The table 300 has a first column 302 for storing a CIN, a second column 304 for storing a code of a structural feature, and a third column 306 for storing a fault identifier. In the table 300, a plurality of reference cases 308, 310, 312, 314 are stored. The reference case 308 having a CIN RCD1H1 includes a structural feature SF111 and a fault identifier FI11. The reference case 310 having a CIN RCD2H2, includes four reference structural features SF221, SF222, SF223, and SF224 and a fault identifier FI22. It may be noted herein that a single case may have a plurality of same reference structural features, for example, 7A14 in the reference case 310. The reference case 312 having a CIN RCD3H3, includes a reference structural feature SF331 and a fault identifier FI33. The reference case 314 having a CIN RCD4H4, includes two reference structural features SF441 and SF442 and a fault identifier FI44. In certain embodiment, the table 300 may also include another column for providing a reliability indicator for each of the fault identifier. It should be noted herein that the table 300 in this embodiment, is for illustrative purposes only and should not be interpreted as limiting the scope of the invention. In an alternative embodiment, the exemplary information may be stored in more than one table. For example, a first table may have columns for storing a CIN and corresponding structural features and a second table may include column for storing fault identifier and corresponding CIN. In some other embodiments, the database may also store additional parameters related to the operation of the machine. Additional parameters may include a category of the machine, date of entry corresponding to the reference case, and other relevant information.

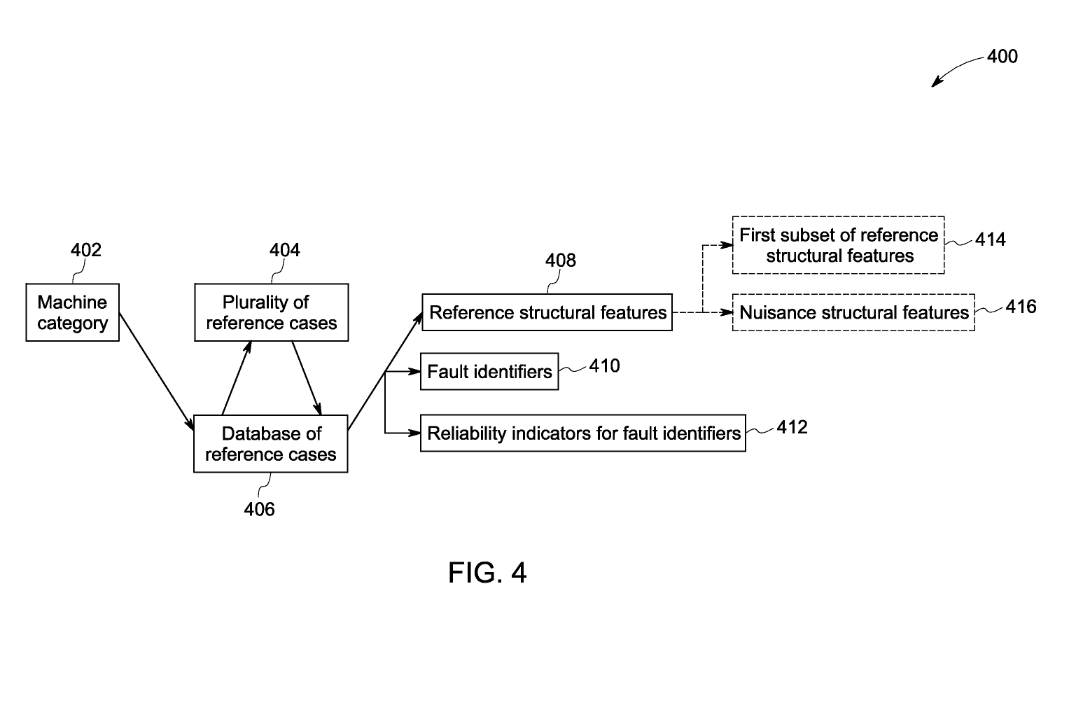

FIG. 4 is a block diagram 400 showing obtaining of a plurality of reference structural features from a database based on the sensory data in accordance with an exemplary embodiment. A category 402 of a machine generating the sensory data is determined based on a CIN. A plurality of reference cases 404 are retrieved from a data base 406 based on the category 402 of the machine generating the sensory data. Each reference case has a CIN stored in one or more tables of the database 406. A plurality of reference structural features 408 are retrieved from the database 406 based on the CIN. The plurality of reference structural features 408 includes a first subset 414 of reference structural features and a plurality of nuisance structural features 416. The first subset 414 of reference structural features are determined from the plurality of reference structural features 408. At least one fault identifier is extracted from the database 406 for each CIN and thereby a plurality of fault identifiers 410 are identified. A reliability indicator corresponding to each fault identifier is retrieved from the database 406 and thereby a plurality of reliability indicators 412 are identified. It should be noted herein that for one reference case among the plurality of reference cases 404, a fault identifier may not represent the operating condition of the machine characterized by a plurality of reference structural features associated with the corresponding reference case. Accuracy of the first subset 414 of reference structural features is enhanced by excluding processing of such a reference case. The reliability indicator is a measure of the validity of the corresponding fault identifier in the database for a plurality of reference structural features. In other words, a reliability indicator having a higher value is a more accurate indication of the operating condition of the machine characterized by the plurality of reference structural features. The reliability indicator is used to reduce the number of reference structural features from the plurality of reference structural features. The technique of reducing the number of reference structural features is explained in greater detail below.

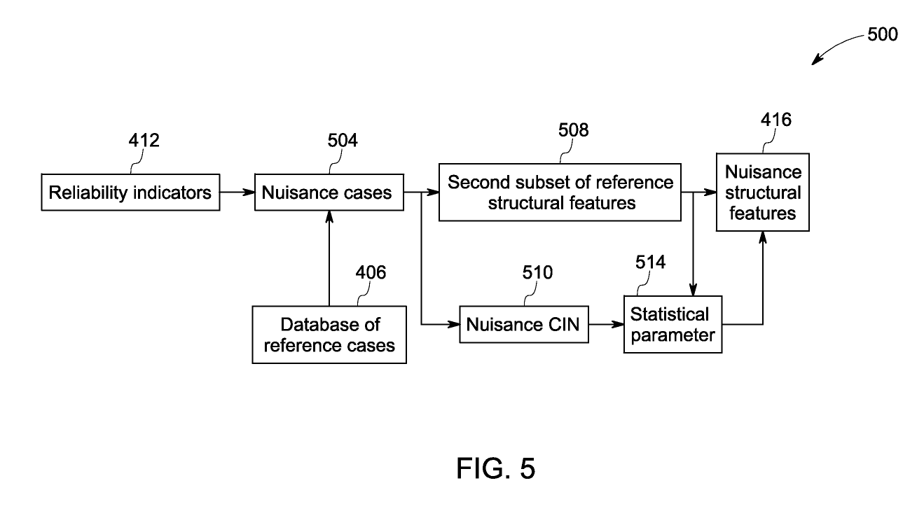

FIG. 5 is a block diagram 500 illustrating identification of a plurality of nuisance structural features from a plurality of reference structural features in accordance with an exemplary embodiment. A plurality of nuisance cases 504 are obtained from the plurality of reference cases stored in the database 406, based on the plurality of reliability indicators 412. A nuisance case is a reference case having an unreliable fault identifier. In one embodiment, all reference cases having a reliability indicator less than a first threshold value are identified as “nuisance cases”. In one specific embodiment, the first threshold value is a pre-defined threshold value. The pre-defined threshold value may be defined by the user. In an alternate embodiment, the pre-defined threshold value is retrieved from the database based on the category of the machine. A second subset 508 of reference structural features corresponding to the plurality of obtained nuisance cases 504 is identified. In one embodiment, the second subset may include a single reference structural feature listed repeatedly. A plurality of CINs corresponding to the obtained nuisance cases 504 are also identified 510.

The plurality of nuisance structural features 416 are obtained based on the second subset 508 of reference structural features corresponding to the plurality of obtained nuisance cases. A statistical parameter is computed 514 based on the plurality of reference cases. In an exemplary embodiment, the statistical parameter is a frequency parameter used to determine the plurality of nuisance structural features. In such an embodiment, the frequency parameter is assigned to each of the reference structural feature of the second subset. In one embodiment, the frequency parameter is determined based on a number of cases among the plurality of nuisance cases 504, having a reference structural feature. In an alternate embodiment, the number of repetitions of reference structural feature is considered as the frequency parameter. Similarly, a plurality of frequency parameters corresponding to each reference structural feature of the second subset is determined.

A subset of the plurality of frequency parameters greater than a second threshold value is determined. In one embodiment, the second threshold value is defined by a user. In an alternate embodiment, the second threshold value is retrieved from a database. The reference structural features from the second subset of reference structural features, corresponding to the subset of plurality of frequency parameters, are determined as the plurality of nuisance structural features 416.

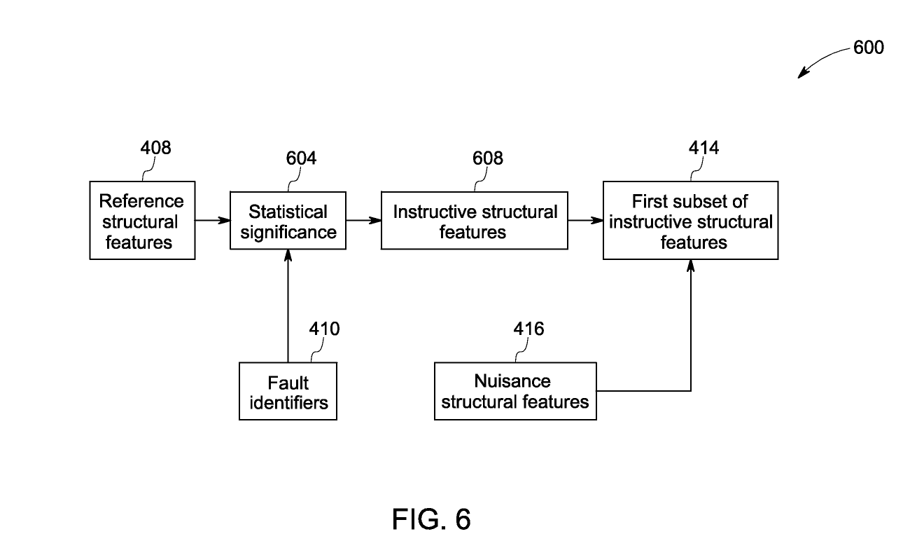

FIG. 6 is a block diagram 600 illustrating identification of an instructive structural feature from the plurality of reference structural features in accordance with an exemplary embodiment. The plurality of reference structural features 408 and the plurality of fault identifiers 410 are used to determine a statistical parameter. In the illustrated embodiment, the statistical parameter is a statistical significance 604 of each reference structural feature with reference to each corresponding fault identifier. In another embodiment, the statistical parameter is a first frequency of occurrence of each reference structural feature with reference to a plurality of reference structural features of the plurality of nuisance cases. The term “statistical significance” used herein refers to a statistical parameter indicative of a probability of incorrectly rejecting one hypothesis instead of another hypothesis. The reference structural feature which is statistically significant is categorized as an “instructive structural feature”. Instructive structural feature is a reference structural feature having useful information for determining an operating condition of the machine. A plurality of instructive structural features are obtained 608 by computing statistical parameter for each reference structural feature. The technique for performing a statistical significance test is explained in greater detail below. The first subset 414 of reference structural features is obtained by selecting the instructive structural features that are not nuisance structural features 416. The first subset 414 of instructive structural features and the measured structural features are used to determine a fault identifier corresponding to the sensory data of the machine.

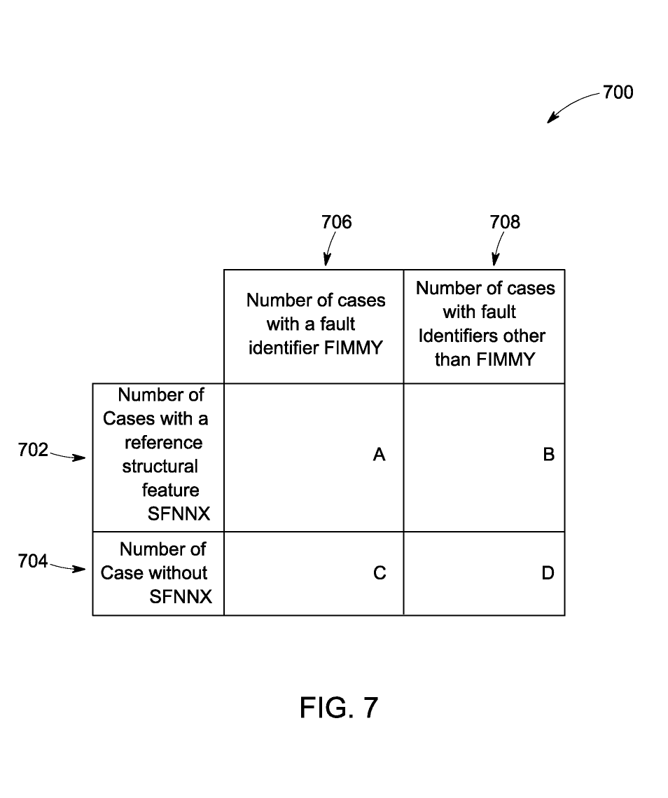

FIG. 7 is a table 700 used to illustrate computation of statistical significance parameter in accordance with an exemplary embodiment. The table 700 is referred herein as a “contingency table” and is constructed with reference to a reference structural feature and a fault identifier. In the illustrated exemplary embodiment, a reference structural feature SFNNX and the fault identifier FIMMY are considered. The table 700 has two rows 702, 704, and two columns 706, 708. The first row 702 is indicative of the number of cases having the reference structural feature SFNNX. The second row 704 is indicative of the number of cases which do not have the reference structural feature SFNNX. The first column 706 is indicative of the number of cases having the fault identifier FIMMY. The second column 708 is indicative of the number of cases which do not have the fault identifier FIMMY. The first row 702 has an entry A representative of the number of cases having the reference structural feature SFNNX and the fault identifier FIMMY corresponding to the first column 706. The first row 702 has another entry B representative of the number of cases that do not have the reference structural feature SFNNX and have the fault identifiers other than FIMMY corresponding to the second column 708. The second row 704 has an entry C indicative of the number of cases that do not have the reference structural feature SFNNX and have the fault identifier FIMMY corresponding to the first column 706. The second row 704 has another entry D representative of the number of cases that do not have the reference structural feature SFNNX and have the fault identifiers other than FIMMY corresponding to the second column 708.

A statistical significance parameter is determined based on the contingency table of FIG. 7. The statistical significance parameter, represented as p, is given by:

$$p = \frac{( A + B ) ! ( C + D ) ! ( A + C ) ! ( A + D ) !}{A ! B ! C ! D ! ( A + B + C + D ) !} \qquad ( 1 )$$

where, A, B, C, and D are entries of the contingency table 700 and the exclamation mark (!) is representative of factorial mathematical operation. If the statistical significance parameter is less than a pre-defined constant value, the reference structural feature SFNNX is determined as “instructive” with reference to the considered fault identifier FIMMY. In a specific example, the value of A is thirty seven, the value of B is twenty one, the value of C is four, the value of D is six hundred and thirty five and the pre-defined constant value is 0.05. In such an example, the statistical significance parameter p is equal to 6.8×10⁻⁴². Since the value of p is smaller than 0.05, the reference structural feature SFNNX is instructive with reference to the fault identifier FIMMY.

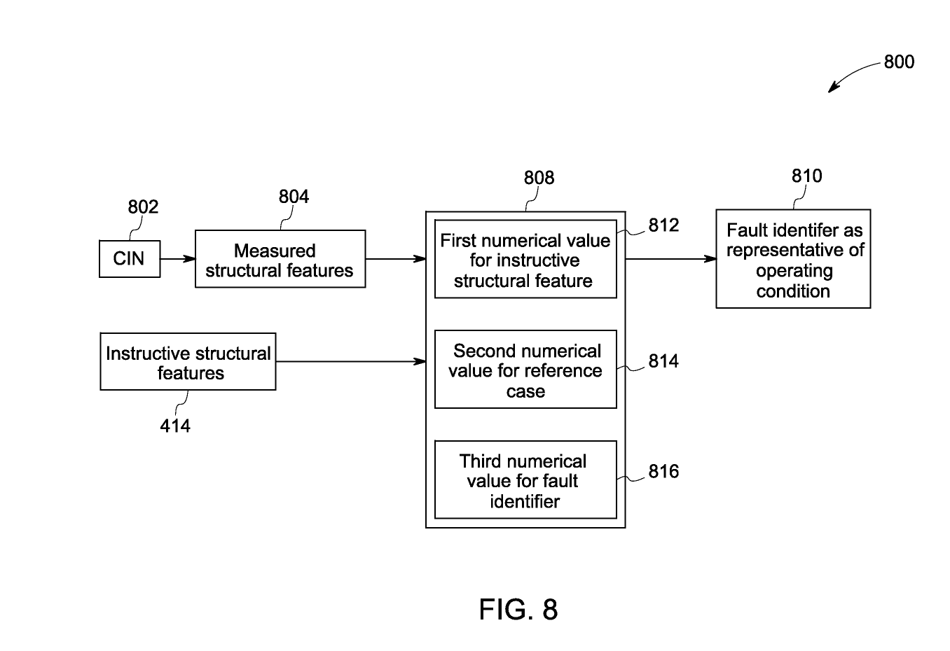

FIG. 8 is a block diagram 800 illustrating generation of at least one fault identifier for sensory data of a machine in accordance with an exemplary embodiment. A CIN 802 corresponding to the sensory data is used to determine measured structural features 804 as explained previously. Similarly, the first subset 414 of reference structural features having a plurality of instructive structural features corresponding to the CIN is obtained as explained previously. A plurality of similarity values are computed 808 based on the first subset 414 of instructive structural features and the measured structural features.

The plurality of similarity values includes a first numerical value 812 of each reference structural feature from the first subset of reference structural features based on a second frequency of occurrence of each reference structural feature with reference to the plurality of measured structural features. In an exemplary embodiment, a structural feature which occurs commonly in the measured structural features and the first subset 414 of reference structural features corresponding to a reference case is considered. The second frequency of occurrence corresponding to the common structural feature is referred to as a ratio of repetition of the common structural feature in the reference case to the repetition of the common structural feature in the measured case. As an example, if CSFID1 is a common structural feature and if CSFID1 is repeated twice in the reference case and four times in the measured case, then the second frequency of occurrence is equal to 0.5. As another example, if CSFID1 occurs once in the reference case and the measured case, then the second frequency of occurrence is equal to one. The second frequency of occurrence may be suitably weighted to determine the first numerical value 812. The first numerical value 812 is represented by:

first_numerical_value=(1−α)+α×second_frequency (2)

where, α is a weighting factor of the second frequency of occurrence. In one example, the value of α is selected as 0.3. In another example, the value of α may be equal to 0.4. It should be noted herein that the equation (2) should not to be construed as a limitation of the invention and the first numerical value 812 may be determined using other similar mathematical formulae indicative of the relative similarity between the measured case and the reference case with reference to the common structural feature.

Further, the plurality of similarity values includes a second numerical value 814 of each reference case determined based on the first numerical value 812 of each reference structural feature. In one embodiment, the plurality of similarity values corresponding to the instructive structural features of the reference case are added together to determine the second numerical value 814 corresponding to the reference case. It should be noted herein that the second numerical value 814 indicative of a similarity value of each reference case with reference to the measured case. The technique of determining a plurality of similarity values corresponding to each reference case is explained in greater detail below.

Further, the plurality of similarity values includes a third numerical value 816 of each fault identifier determined based on the second numerical value 814 of each reference case. In an exemplary embodiment, the third numerical value 816 for a fault identifier is determined by adding a plurality of second numerical values corresponding to a plurality of reference cases having the fault identifier. Further, a plurality of third numerical values corresponding to each of the plurality of fault identifiers are determined. A maximum value among the plurality of third numerical values is then determined and a fault identifier corresponding to the maximum value is identified. The fault identifier 810 is representative of the operating condition of the machine. In an alternate embodiment, a subset of values among the plurality of third values is identified. A plurality of fault identifiers corresponding to the subset of identified values are determined.

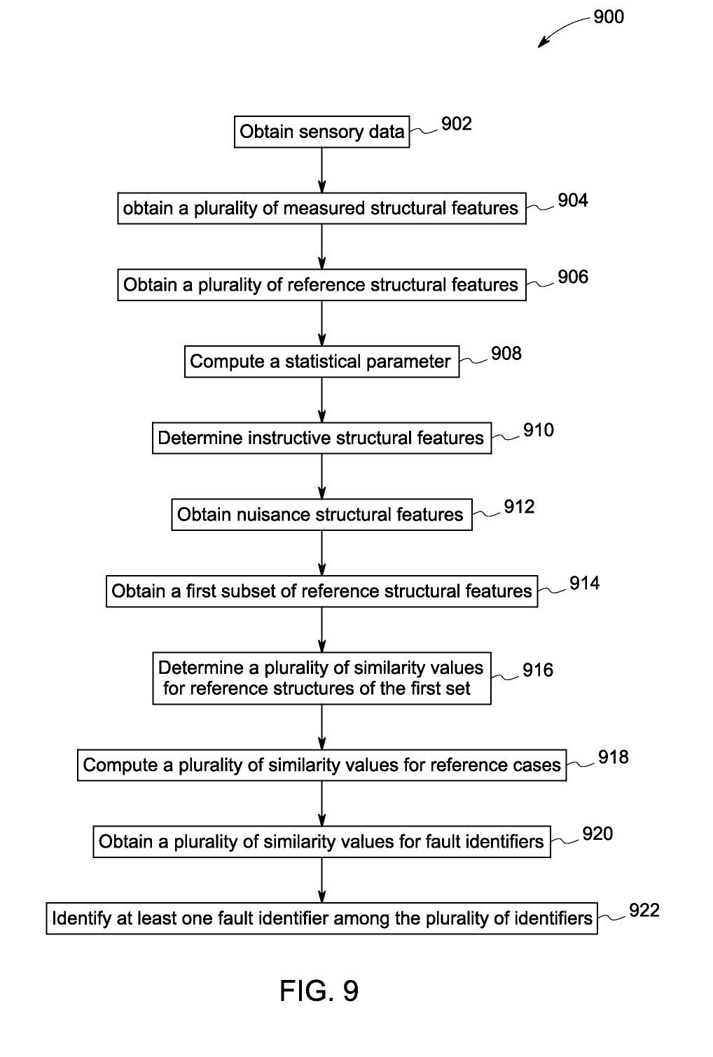

FIG. 9 is a flow chart 900 illustrating a method of identifying at least one fault identifier from a sensory data of an operating machine in accordance with an exemplary embodiment. The sensory data is obtained 902 from the machine and a plurality of measured structural features are obtained 904 based on the obtained sensory data. Each measured structural feature includes at least one of a fault and a sequence of faults. A plurality of reference cases are obtained from a database based on a category of the machine which generates the sensory data. Each reference case has one or more reference structural features. A plurality of reference structural features are obtained 906 from the database, corresponding to the plurality of reference cases. Each reference structural feature also includes a fault and a sequence of faults. The database also includes a plurality of fault identifiers corresponding to each reference case. The database further includes a reliability indicator for each fault identifier. The database may be updated with additional reference cases and corresponding reference structural features when the sensory data is analyzed and new operating conditions are determined.

A statistical parameter is computed 908 based on the plurality of reference cases and the plurality of reference structural features. In one embodiment, a plurality of statistical parameters are computed. In one such embodiment, a first parameter from the plurality of statistical parameters is used to determine an instructive structural feature. In one specific embodiment, the first parameter is a statistical significance of each reference structural feature with reference to each corresponding fault identifier. In such a manner, a plurality of instructive structural features are determined 910 from the plurality of reference structural features. In another embodiment, a second parameter from the plurality of statistical parameters is used to determine a nuisance structural feature. In one such embodiment, the second parameter is a first frequency of occurrence of each reference structural feature with reference to a plurality of reference structural features of the plurality of nuisance cases. In such a manner, a plurality of nuisance structural features are determined 912 from the reference structural features.

A first subset of reference structural features is obtained 914 based on the instructive structural features and the nuisance structural features identified from the plurality of reference structural features. The first subset includes the instructive structural features and excludes the nuisance structural features. A plurality of similarity values for reference structural features of the first subset is determined 916. The plurality of similarity values are determined based on the reference structural features of each reference case and the plurality of measured structural features. Specifically, the plurality similarity values are determined based on a frequency of occurrence of each reference structural feature of the reference case, within the plurality of measured structural features.

A plurality of similarity values for each reference case are determined 918 based on the plurality of similarity values for the reference structural features corresponding to the each of the plurality of reference cases. A plurality of similarity values for each of the fault identifier is obtained 920 based on the similarity values for the plurality of reference cases corresponding to each fault identifier. At least one fault identifier is determined 922 based on the plurality of similarity values corresponding to the plurality of fault identifiers.

Exemplary embodiments of the case-based reasoning technique disclosed herein enables determination of at least one fault identifier among a plurality of fault identifiers associated with a plurality of reference cases representative of an operating condition of the machine. Determination of instructive structural features from the plurality of reference structural features for computing the plurality of similarity values facilitates reduction of false alarms while diagnosing an operating condition of the machine. It is to be understood that not necessarily all such objects or advantages described above may be achieved in accordance with any particular embodiment. Thus, for example, those skilled in the art will recognize that the systems and techniques described herein may be embodied or carried out in a manner that achieves or improves one advantage or group of advantages as taught herein without necessarily achieving other objects or advantages as may be taught or suggested herein.

While the technology has been described in detail in connection with only a limited number of embodiments, it should be readily understood that the invention are not limited to such disclosed embodiments. Rather, the technology can be modified to incorporate any number of variations, alterations, substitutions or equivalent arrangements not heretofore described, but which are commensurate with the spirit and scope of the claims. Additionally, while various embodiments of the technology have been described, it is to be understood that aspects of the inventions may include only some of the described embodiments. Accordingly, the inventions are not to be seen as limited by the foregoing description, but are only limited by the scope of the appended claims. What is claimed as new and desired to be protected by Letters Patent of the United States is:

1. A method comprising:
obtaining sensory data from a machine;
obtaining a plurality of measured structural features based on the sensory data;
obtaining a plurality of reference cases corresponding to the sensory data, from a database, wherein the plurality of reference cases comprises a plurality of reference structural features and a plurality of fault identifiers;
computing a statistical parameter based on the plurality of reference cases;
obtaining a first subset of reference structural features from the plurality of reference structural features based on the computed statistical parameter;
computing a plurality of similarity values based on the obtained first subset of reference structural features and the plurality of measured structural features; and
identifying at least one fault identifier among the plurality of fault identifiers, based on the computed plurality of similarity values.

2. The method of claim 1, wherein each measured structural feature comprises at least one of a fault and a sequence of faults.

3. The method of claim 1, wherein each reference structural feature comprises at least one of a fault and a sequence of faults.

4. The method of claim 1, wherein the computed statistical parameter comprises a statistical significance of each reference structural feature with reference to each corresponding fault identifier.

5. The method of claim 4, wherein obtaining the first subset comprises determining an instructive structural feature from the plurality of reference structural features based on the statistical significance.

6. The method of claim 1, wherein the plurality of reference cases comprises a nuisance case having a second subset of reference structural features, selected from the plurality of reference structural features based on a reliability indicator.

7. The method of claim 6, wherein the computed statistical parameter comprises a first frequency of occurrence of each reference structural feature with reference to the second subset of reference structural features.

8. The method of claim 7, wherein the obtaining the first subset comprises determining a nuisance structural feature from the second subset of reference structural features based on the first frequency.

9. The method of claim 7, wherein the plurality of similarity values comprises a first numerical value of each reference structural feature from the first subset of reference structural features determined based on a second frequency of occurrence of each reference structural feature with reference to the plurality of measured structural features.

10. The method of claim 9, wherein the plurality of similarity values comprises a second numerical value of each reference case determined based on the first numerical value of each reference structural feature from the first subset of reference structural features.

11. The method of claim 10, wherein the plurality of similarity values comprises a third numerical value of each fault identifier determined based on the second numerical value of each reference case.

12. A system, comprising:
a data acquisition module communicatively coupled to a sensing unit of a machine, wherein the data acquisition module is configured to obtain a sensory data comprising a plurality of measured structural features from the sensing unit;
a training module communicatively coupled to the data acquisition module, the training module comprising:
a database having a plurality of reference cases corresponding to the sensory data, wherein the plurality of reference cases comprises a plurality of reference structural features and a plurality of fault identifiers;
an optimizer module communicatively coupled to the database; wherein the optimizer module is configured to obtain a first subset of reference structural features from the plurality of reference structural features;
an execution module communicatively coupled to the data acquisition module and the optimizer module, wherein the execution module is configured to identify at least one fault identifier among the plurality of fault identifiers, based on the plurality of measured structural features and the first subset of reference structural features.

13. The system of claim 12, wherein each reference structural feature comprises at least one of a fault and a sequence of faults.

14. The system of claim 12, wherein the optimizer module is further configured to compute a statistical parameter based on the plurality of reference cases.

15. The system of claim 12, wherein the optimizer module is further configured to determine a nuisance case from the plurality of reference cases based on a reliability indicator, wherein the nuisance case comprises a second subset of reference structural features selected from the plurality of reference structural features.

16. The system of claim 15, wherein the optimizer module is further configured to determine a nuisance structural feature from the second subset of reference structural features based on a first frequency of occurrence of each reference structural feature with reference to the second subset of reference structural features.

17. The system of claim 16, wherein the execution module is further configured to compute a plurality of similarity values based on the obtained first subset of reference structural features and the plurality of measured structural features.

18. The system of claim 17, wherein the execution module is further configured to compute a first numerical value of each reference structural feature from the first subset of reference structural features based on a second frequency of occurrence of each reference structural feature with reference to the plurality of measured structural features, a second numerical value of each reference case based on the first numerical value, and a third numerical value of each fault identifier based on the second numerical value.

19. The system of claim 12, wherein the optimizer module is further configured to determine an instructive structure feature from the plurality of reference structural features based on a statistical significance of each reference structural feature with reference to each corresponding fault identifier.

20. A non-transitory computer readable medium encoded with a program to instruct at least one processor based device to:
obtain sensory data from a machine;
obtain a plurality of measured structural features based on the sensory data;
obtain a plurality of reference cases corresponding to the sensory data, from a database, wherein the plurality of reference cases comprises a plurality of reference structural features and a plurality of fault identifiers;
compute a statistical parameter based on the plurality of reference cases;
obtain a first subset of reference structural features from the plurality of reference structural features based on the computed statistical parameter;
compute a plurality of similarity values based on the obtained first subset of reference structural features and the plurality of measured structural features; and
identify at least one fault identifier among the plurality of fault identifiers, based on the computed plurality of similarity values.
